(19) United States
(12) Patent Application Publication
(10) Pub. No.: US 2019/0050167 A1
(43) Pub. Date: Feb. 14, 2019

(54) Flash Storage Devices Executing ECC in Parallel and Methods Thereof

(71) Applicant: Silicon Motion, Inc., Jhubei City (TW)

(72) Inventors: Ming-Chang Hsieh, Taoyuan City (TW); Che-Wei Hsu, Taichung City (TW); Wen-Chi Hong, Taichung City (TW)

(21) Appl. No.: 15/922,669

(22) Filed: Mar. 15, 2018

(30) Foreign Application Priority Data
Aug. 11, 2017 (TW) 106127272

(51) Int. Cl. G06F 3/06; G06F 9/38; G06F 11/14; G06F 11/10

(52) U.S. Cl. CPC G06F 3/0659; G06F 9/3836; G06F 3/0679; G06F 11/1044; G06F 11/108; G06F 11/1402

(57) ABSTRACT

A storage device receiving an external instruction from a host includes a plurality of flash memory spaces and a controller. The controller receives the external instruction, queues the external instruction in a first command queue, translates the external instruction into a plurality of operation commands, and sequentially executes the operation commands to respectively operate the flash memory spaces. The controller further gives an identity code to at least one specific operation command to track the execution result of the specific operation command.

### CROSS REFERENCE TO RELATED APPLICATIONS

This Application claims priority of Taiwan Patent Application No. 106127272, filed on Aug. 11, 2017, the entirety of which is incorporated by reference herein.

### BACKGROUND OF THE INVENTION

### Field of the Invention

The disclosure relates generally to flash storage devices and reading methods thereof, and more particularly it relates to flash storage devices capable of executing ECC in parallel and reading methods thereof.

### Description of the Related Art

ECC decoding should be executed when a flash memory performs an access operation, and the time for ECC decoding depends on the bandwidth and efficiency of the ECC decoder. When executing a command to directly access the memory (read DMA), it takes time waiting for the results of the ECC decoder to determine whether the ECC is successful.

Since the ECC decoder is shared by multiple channels, there is a long delay time when multiple channels share the ECC decoder. Therefore, it is necessary for the access operation of a flash memory to be optimized.

### BRIEF SUMMARY OF THE INVENTION

In an embodiment, a storage device receiving an external instruction from a host comprises a plurality of flash memory spaces and a controller. The controller receives the external instruction and queues the external instruction in a first command queue. The controller translates the external instruction into a plurality of operation commands. The controller sequentially executes the operation commands to respectively operate the flash memory spaces. The controller further gives an identity code to at least one specified operation command of the operation commands for tracking an execution result of at least one specified operation command.

According to an embodiment of the invention, the controller comprises an input/output controller and a central-processing unit. The input/output controller receives the external instruction via an input/output interface. The central-processing unit queues the external instruction in an internal command queue and, either sequentially or according to priority, transmits the external instruction from the internal command queue to the first command queue.

According to an embodiment of the invention, the controller further comprises: a flash memory controller. The flash memory controller comprises the first command queue and a second command queue. The flash memory controller translates the external instruction queued in the first command queue into the operation commands, and queues the operation commands in the second command queue.

According to an embodiment of the invention, the flash memory controller gives the identity code to the at least one specified operation command. When the flash memory controller executes the at least one specified operation command, the flash memory controller simultaneously transmits the identity code and the at least one specified operation command to an ECC encoder/decoder. The ECC encoder/decoder generates the execution result and processed data according to the at least one specified operation command.

According to an embodiment of the invention, the ECC encoder/decoder further associates the execution result and the processed data with the identity code. The flash memory controller periodically accesses the execution result according to the identity code, and determines whether the execution result is successful. When the flash memory controller determines the execution result is unsuccessful, the flash memory controller executes a data-recovery process.

In an embodiment, a method adopted in a plurality of flash memory spaces comprises: receiving an external instruction from a host; translating the external instruction into a plurality of operation commands; giving an identity code to at least one specified operation command among the operation commands; sequentially executing the operation commands to operate the flash memory spaces; and tracking an execution result of the at least one specified operation command according to the identity code.

According to an embodiment of the invention, the method further comprises: queuing the received external instruction in a first command queue; translating the external instruction in the first command queue into the operation commands; queuing the operation commands in a second command queue; and when executing the at least one specified operation command, simultaneously transmitting the identity code and the at least one specified operation command.

According to an embodiment of the invention, the method further comprises: periodically accessing an execution result of the at least one specified operation command according to the identity code; and determining whether the execution result is successful.

According to an embodiment of the invention, the method further comprises: when determining that the execution result is successful, removing the operation commands corresponding to the external instruction from the second command queue; when determining that the execution result is unsuccessful, executing a data-recovery process; and when determining that the execution result is unsuccessful once again, queuing the operation commands in a second command queue once again.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a storage device in accordance with an embodiment of the invention;

FIG. 2 is a schematic diagram of a command sequence in accordance with an embodiment of the invention;

FIG. 3 is a flow chart of a method for executing commands in accordance with an embodiment of the invention; and

FIG. 4 is a schematic diagram of a command sequence in accordance with another embodiment of the invention.

### DETAILED DESCRIPTION OF THE INVENTION

This description is made for the purpose of illustrating the general principles of the invention and should not be taken in a limiting sense. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

It is understood that the following disclosure provides many different embodiments, or examples, for implementing different features of the application. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact.

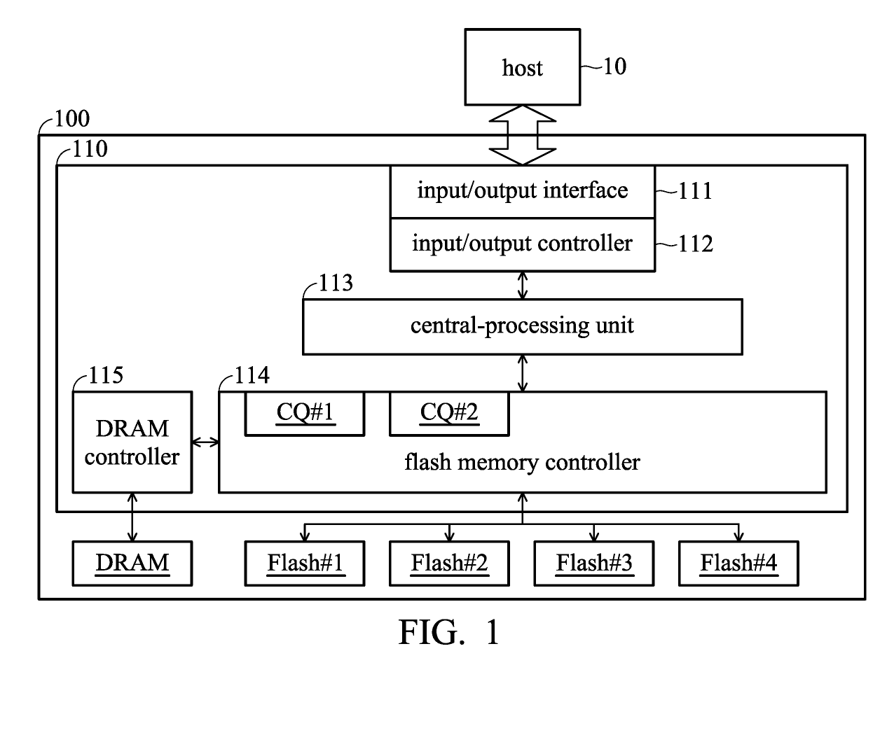

FIG. 1 is a block diagram of a storage device in accordance with an embodiment of the invention. According to an embodiment of the invention, the storage device is a flash memory. For the convenience of explanation, only a single channel alternatively operating a plurality of memory spaces according to Chip Enable Signals is illustrated in FIG. 1. A first flash memory space Flash#1, a second flash memory space Flash#2, a third flash memory space Flash#3, and a fourth flash memory space Flash#4 are illustrated herein for explanation. According to an embodiment of the invention, the first flash memory space Flash#1, the second flash memory space Flash#2, the third flash memory space Flash#3, and the fourth flash memory space Flash#4 may be separate dies. According to another embodiment of the invention, the first flash memory space Flash#1, the second flash memory space Flash#2, the third flash memory space Flash#3, and the fourth flash memory space Flash#4 may be separate logic unit numbers (LUN). When there is more than one channel, the architecture of FIG. 1 can be duplicated and modified accordingly to satisfy user's requirement.

FIG. 1 further illustrates the controller 110 of the storage device 100. The controller 110 may operate the first flash memory space Flash#1, the second flash memory space Flash#2, the third flash memory space Flash#3, and the fourth flash memory space Flash#4 according to the external instructions of the host 10, such as NVM Express (NVMe). According to an embodiment of the invention, the storage device 100 may utilize DRAM as data buffer for accelerating data access, but not intended to be limited thereto. The controller 110 includes an input/output interface 111, an input/output controller 112, a central-processing unit 113, a flash memory controller 114, and a DRAM controller 115. The input/output controller 112 receives the external instructions from the host 10 through the input/output interface 111. The central-processing unit 113 queues the external instructions received by the input/output controller 112 in the external instruction queue CQ#0 (not shown in FIG. 1), and either sequentially or according to priority, transmits the external instructions to the flash memory controller 114. It is preferable for the internal command queue CQ#0 to be built into the built-in SRAM in the controller 110 or to be built into the DRAM via the DRAM controller 115.

It is preferable that the flash memory controller 114 creates the first command queue CQ#1 and the second command queue CQ#2 in the built-in SRAM of the controller 110. The first command queue CQ#1 may be configured to queue the external instructions, and the second command queue CQ#2 may be configured to queue the flash memory operation commands translated from an external instruction (hereinafter referred to as the operation command). The flash memory controller 114 performs the operations, according to the operation command, on the first flash memory space Flash#1, the second flash memory space Flash#2, the third flash memory space Flash#3, and the fourth flash memory space Flash#4. According to an embodiment of the invention, it is preferable that the central-processing unit 113 and the flash memory controller 114 are integrated into the same chip. According to another embodiment of the invention, the central-processing unit 113 and the flash memory controller 114 may exist independently (i.e., in different chips).

The controller 110 further includes ECC encoder/decoder. The ECC decoder may generate the parity code (PC) according to the data, and then perform the ECC operation on the data according to the parity code. When the data does not contain any parity code or the number of error bits does not exceed a threshold, the ECC decoder may correct the error bits in the data according to the parity code and return a message indicating that the data has been successfully corrected. When the data has not been corrected, ECC decoder may return a message indicating that the correction was unsuccessful. The flash memory controller 114 may store the data and the parity code in any one of the first flash memory space Flash#1, the second flash memory space Flash#2, the third flash memory space Flash#3, and the fourth flash memory space Flash#4. According to an embodiment of the invention, the data and the parity code are preferably stored in the same storage space of the flash memory, such as the same page. According to other embodiments of the invention, the data and the parity code may be adjacently stored, or separately stored.

Taking data reading for example, since the circuit size of the ECC encoder/decoder is very large, in the process of data reading, the data and the parity code from several flash memory spaces, such as the first flash memory space Flash#1 and the second memory space Flash#2, are transmitted to an ECC encoder/decoder. According to another embodiment of the invention, the data and the parity code from all the flash memory spaces, such as the first flash memory space Flash#1, the second flash memory space Flash#2, the third flash memory space Flash#3, and the fourth flash memory space Flash#4, are transmitted to an ECC encoder/decoder. Therefore, the capability of the ECC encoder/decoder determines the access performance of the storage device. In addition, since the ECC encoder/decoder needs a longer time to perform ECC encoding/decoding, the bottleneck of the system performance of the storage device is ECC encoding/decoding. Therefore, how to effectively execute the operation commands and to reduce the time for data encoding/decoding becomes an important technical issue.

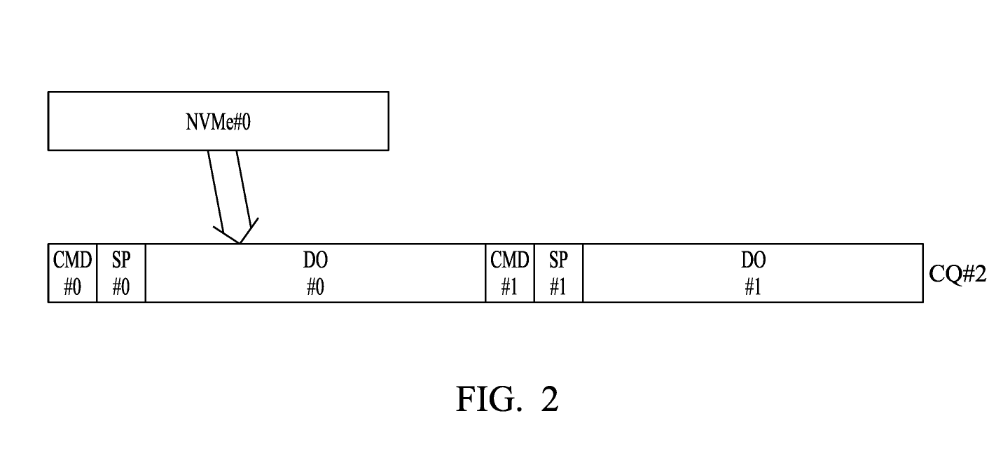

FIG. 2 is a schematic diagram of a command sequence in accordance with an embodiment of the invention. As shown in FIG. 2, the external instruction NVMe#0 is translated into three operation commands which are a read command CMD#0, a status-polling command SP#0, and data-outputting command DO#0. In addition, the external instructions and the operation commands may be in one-to-one correspondence. According to another embodiment of the invention, the external instructions and the operation commands may be in one-to-multiple correspondence. For example, the read commands CMD#0 and CMD#1, the status-polling commands ST#0 and ST#1, and the data-outputting commands DO#0 and DO#1 correspond to the external instruction NVMe#0.

The data-outputting command DO#0 may transmit the data and the parity code in the flash memory space to the ECC encoder/decoder. In addition, it is preferable that DMA be used for the data transmission between the flash memory space and the ECC encoder/decoder in order to increase the data transmission speed between the flash memory space and the ECC encoder/decoder. The loading of the data transmitted to the central-processing unit 113 or the flash memory controller 114 is therefore reduced.

The execution time of the data-outputting command DO further includes the execution time of the ECC encoder/decoder. The ECC encoder/decoder needs a period of time for correcting the data and an event of correction fail may be occurred. Therefore, after executing the data-outputting command DO#0, the flash memory controller 114 not only needs a period of time to wait for the data and the parity code transmitted from the flash memory space to the ECC encoder/decoder, but it also needs a period of time to wait for the execution result to be returned from the ECC encoder/decoder. When the execution result indicates that the correction is successful, the flash memory controller 114 may execute next operation command, such as the reading command CMD#1. When the execution result indicates that the correction is unsuccessful, the flash memory controller 114 activates the recovery process to execute, by resetting the operation conditions of the flash memory space, the reading command CMD#0, the status-polling command ST#0, and the data-outputting command DO#0 over and over until the execution result indicating that the correction is successful.

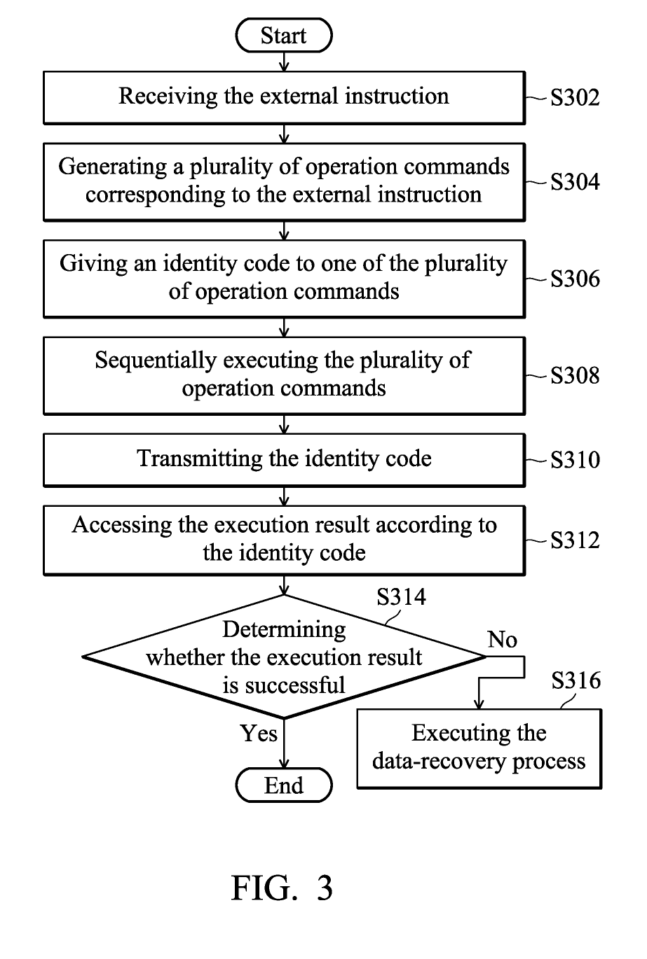

FIG. 3 is a flow chart of a method for executing commands in accordance with an embodiment of the invention, which is adopted in the non-volatile memory as the storage device. In Step S302, the external instruction is received and queued. The central-processing unit 113 receives the external instruction from the host 10 and queues the external instruction in the internal command queue CQ#0. The flash memory controller 114 further receives the external instruction from the central-processing unit 113 and queues the external instruction in the first command queue CQ#1.

In Step S304, a plurality of operation commands corresponding to the external instruction is generated. The flash memory controller 114 sequentially translates the external instructions queued in the first command queue CQ#1 into a plurality of operation commands. For example, the external instruction is translated into the reading command CMD#0, the status-polling command ST#0, and the data-outputting command DO#0. The translated operation commands are queued in the second command queue CQ#2 and are waiting to be sequentially executed.

In Step S306, an identity code is given to one of the plurality of operation commands, which is configured to track the execution result of a specified operation command. For example, the flash memory controller 114 gives the identity code ID#0 to the data-outputting command DO#0 and the identity code ID#1 to the data-outputting command DO#1. According to another embodiment of the invention, the flash memory controller 114 may also give an identity code to the plurality of operation commands rather than an identity code to a specified operation command. For example, the identity code ID#0 is given to the reading command CMD#0, the status-polling command ST#0, and the data-outputting command DO#0, and the identity code ID#1 is given to the reading command CMD#1, the status-polling command ST#1, and the data-outputting command DO#1.

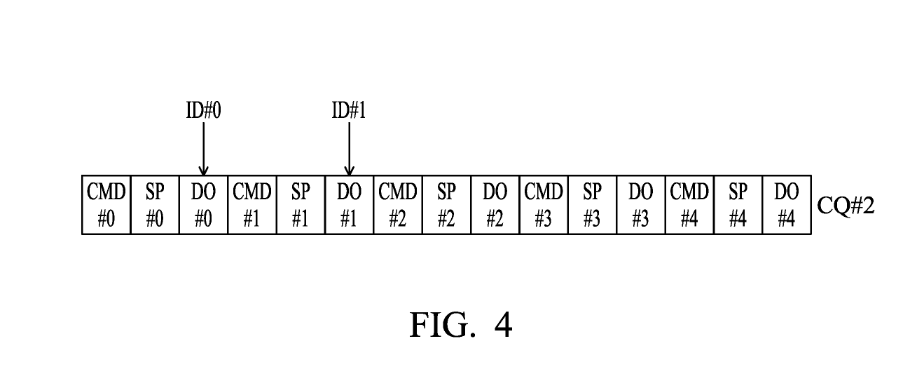

FIG. 4 is a schematic diagram of a command sequence in accordance with another embodiment of the invention. As shown in FIG. 4, the identity code ID#0 is given to the data-outputting command DO#0, and the identity code ID#1 is given to the data-outputting command DO#1.

In Step S308, the plurality of operation commands are sequentially executed. As shown in FIG. 4, the flash memory controller 114 executes the reading command CMD#0, the status-polling command ST#0, the data-outputting command DO#0, the reading command CMD#1, the status-polling command ST#1, the data-outputting command DO#1, and so on, in sequence.

In Step S310, the identity code is transmitted. When the flash memory controller 114 executes the specified operation command, the identity code is transmitted thereafter or at the same time. For example, when the data-outputting command DO#0 is executed, the identity code ID#0 is then, or simultaneously, transmitted to the ECC encoder/decoder. When the data-outputting command DO#1 is executed, the identity code is then, or simultaneously, transmitted to the ECC encoder/decoder. In other words, the ECC encoder/decoder not only receives the data and the parity code from the memory spaces Flash#1˜Flash#4, but it also receives and records the identity code from the flash memory controller 114 and associates the data with the identity code. After Step S310 is executed, the flash memory controller 114 may re-execute Step S308 without waiting for the message from the ECC encoder/decoder which indicates that the execution is complete. Since next operation command may be operated in parallel with the ECC encoder/decoder, the execution speed is accelerated to achieve the purpose of the invention. As shown in FIG. 4, the time required for executing the data-outputting command DO#0 and the data-outputting command DO#1 are noticeably reduced.

In Step S312, the execution result is accessed according to the identity code. After the ECC encoder/decoder finishes data-decoding, the ECC encoder/decoder associates the data and the execution result with the identity code and stores in the SRAM. The flash memory controller 114 may periodically, or according to other settings, check the data in the SRAM, and find out the execution result of the data-outputting instruction DO according to the identity code.

In Step S314, whether the execution result is successful or not is determined. It is assumed that the data DT#0 is stored in the SRAM, that the execution result being successful indicates that the ECC correction is successful, and that the identity code is ID#0. The flash memory controller 114 determines that the execution result of the data-outputting command DO#0 is successfully-corrected to end the method in FIG. 3. According to another embodiment of the invention, Step S302 is re-executed. According to yet another embodiment of the invention, the flash memory controller 114 may remove the reading command CMD#0, the status-polling command ST#0, and the data-outputting command DO#0 from the second command queue CQ#2 such that the second command queue CQ#2 is able to accommodate other operation commands.

It is assumed that the data DT#1 is stored in the SRAM, that the execution result indicates that the correction is unsuccessful, and that the identity code is ID#1. The flash memory controller 114 determines that the execution result of the data-outputting command DO#1 has been unsuccessfully corrected and executes Step S316. In Step S316, the data-recovery process is executed. The flash memory controller 114 may once again try to correct the data DT#1. The data-recovery process will not be explained herein since it is conventional.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A storage device receiving an external instruction from a host, comprising:
a plurality of flash memory spaces; and
a controller, receiving the external instruction and queuing the external instruction in a first command queue, wherein the controller translates the external instruction into a plurality of operation commands, wherein the controller sequentially executes the operation commands to respectively operate the flash memory spaces, wherein the controller further gives an identity code to at least one specified operation command among the operation commands for tracking an execution result of at least one specified operation command.

2. The storage device of claim 1, wherein the controller comprises:
an input/output controller, receiving the external instruction via an input/output interface; and
a central-processing unit, queuing the external instruction in an internal command queue and, either sequentially or according to priority, transmitting the external instruction from the internal command queue to the first command queue.

3. The storage device of claim 2, wherein the controller further comprises:
a flash memory controller, comprising the first command queue and a second command queue, wherein the flash memory controller translates the external instruction queued in the first command queue into the operation commands, and queues the operation commands in the second command queue.

4. The storage device of claim 3, wherein the flash memory controller gives the identity code to the at least one specified operation command, wherein when the flash memory controller executes the at least one specified operation command, the flash memory controller simultaneously transmits the identity code and the at least one specified operation command to an ECC encoder/decoder, wherein the ECC encoder/decoder generates the execution result and processed data according to the at least one specified operation command.

5. The storage device of claim 4, wherein the ECC encoder/decoder further associates the execution result and the processed data with the identity code, wherein the flash memory controller periodically accesses the execution result according to the identity code, and determines whether the execution result is successful, wherein when the flash memory controller determines the execution result is unsuccessful, the flash memory controller executes a data-recovery process.

6. A method adopted in a plurality of flash memory spaces, comprising:
receiving an external instruction from a host;
translating the external instruction into a plurality of operation commands;
giving an identity code to at least one specified operation command among the operation commands;
sequentially executing the operation commands to operate the flash memory spaces; and
tracking an execution result of the at least one specified operation command according to the identity code.

7. The method of claim 6, further comprising:
queuing the received external instruction in a first command queue;
translating the external instruction in the first command queue into the operation commands;
queuing the operation commands in a second command queue; and
when executing the at least one specified operation command, simultaneously transmitting the identity code and the at least one specified operation command.

8. The method of claim 7, further comprising:
periodically accessing an execution result of the at least one specified operation command according to the identity code; and
determining whether the execution result is successful.

9. The method of claim 8, further comprising:
when determining that the execution result is successful, removing the operation commands corresponding to the external instruction from the second command queue;
when determining that the execution result is unsuccessful, executing a data-recovery process; and
when determining that the execution result is unsuccessful once again, queuing the operation commands in a second command queue once again.
